(19) United States
(12) Patent Application Publication
(10) Pub. No.: US 2026/0089371 A1
(43) Pub. Date: Mar. 26, 2026

(54) CAMERA MODULE

(71) Applicant: SAMSUNG ELECTRO-MECHANICS CO., LTD., Suwon-si (KR)

(72) Inventors: Yong Chan LEE, Suwon-si (KR); Kyo Seong JEON, Suwon-si (KR)

(73) Assignee: SAMSUNG ELECTRO-MECHANICS CO., LTD., Suwon-si (KR)

(21) Appl. No.: 19/189,746

(22) Filed: Apr. 25, 2025

(30) Foreign Application Priority Data
Sep. 20, 2024 (KR) 10-2024-0127632

(51) Int. Cl. H04N 23/51; H04N 23/55

(52) U.S. Cl. CPC H04N 23/51; H04N 23/55

(57) ABSTRACT

A camera module includes a lens module; a housing, including a first portion having an end with a curved contour, accommodating the lens module; and a supporting member, including a second portion disposed to face the first portion and having an end with a curved contour corresponding to the curved contour of the first portion, the supporting member disposed on one side of the housing. The first portion has a first coupling portion with an open top towards the supporting member, and the second portion has a second coupling portion with an open top, at least on one side, in a region corresponding to the first coupling portion.

### CROSS-REFERENCE TO RELATED APPLICATIONS

This application claims the benefit under 35 USC 119(a) of Korean Patent Application No. 10-2024-0127632 filed on Sep. 20, 2024, in the Korean Intellectual Property Office, the entire disclosure of which is incorporated herein by reference for all purposes.

### BACKGROUND

### 1. Field

The following description relates to a camera module.

### 2. Description of the Background

Modern vehicles are increasingly equipped with cameras for advanced driver assistance systems (ASAS), including front and rear cameras, as well as surround view monitoring (SVM) cameras. It is expected that future vehicles will be equipped with a variety of cameras with multiple functions.

Likewise, the development of new technologies such as autonomous driving requires high precision in camera modules. However, there is an issue in that the optical axis and rotation of the lens module are affected by the quality level of the parts (planarity, tolerance, etc.) or the process during the bracket assembly of the vehicle camera module, resulting in the optical axis being misaligned in the final product.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens module; a housing, including a first portion having an end with a curved contour, accommodating the lens module; and a supporting member, including a second portion disposed to face the first portion and having an end with a curved contour corresponding to the curved contour of the first portion, the supporting member disposed on one side of the housing. The first portion has a first coupling portion with an open top towards the supporting member, and the second portion has a second coupling portion with an open top, at least on one side, in a region corresponding to the first coupling portion.

The first portion and the second portion may be in contact with each other.

The first portion, in contact with the second portion, may be disposed such that the housing is relatively movable with respect to the supporting member.

The housing, rotatable around on an optical axis of the lens module, may be disposed to be in contact with the supporting member.

The housing, rotatable around a first axis perpendicular to an optical axis of the lens module, may be disposed to be in contact with the supporting member.

The housing, rotatable around an optical axis and a second axis perpendicular to the first axis, may be disposed to be in contact with the supporting member.

The supporting member may include a bracket.

The camera module may further include a coupling member disposed at the first coupling portion and the second coupling portion to mutually couple the housing and the supporting member.

The first coupling portion may be a recessed groove on a surface of the housing.

The second coupling portion may have an aperture that extends through a surface of the supporting member.

The curved contour of the first portion and the curved contour of the second portion may have a same curvature.

In another general aspect, a camera module includes a lens module; a housing, accommodating the lens module, including a first portion having an end with a curved contour; and a supporting member, including a second portion having an end with a curved contour disposed to rotatably abut the first portion. The first portion has a first coupling portion with an aperture facing the supporting member, and the second portion has a second coupling portion with an aperture that extends through a surface of the second portion.

The supporting member may include a bracket.

The camera module may further include a coupling member disposed at the first coupling portion and the second coupling portion to mutually couple the housing and the supporting member.

Other features and aspects will be apparent from the following detailed description, the drawings, and the claims.

### BRIEF DESCRIPTION OF DRAWINGS

FIG. 1 is a cross-sectional view of a camera module according to an embodiment.

FIG. 2 is an enlarged cross-sectional view of portion A of the camera module according to an embodiment.

FIG. 3 is a perspective view of a camera module according to an embodiment.

FIG. 4 is an enlarged cross-sectional view illustrating the movement of a camera module according to an embodiment.

FIG. 5 illustrates an optical axis adjustment of a camera module according to an embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

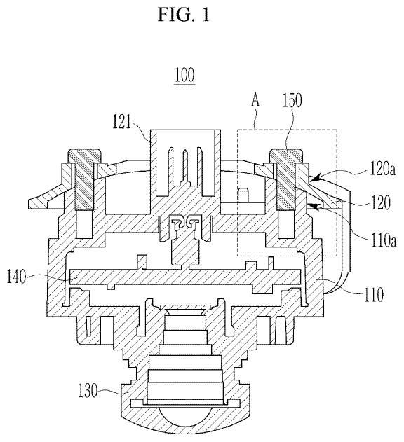

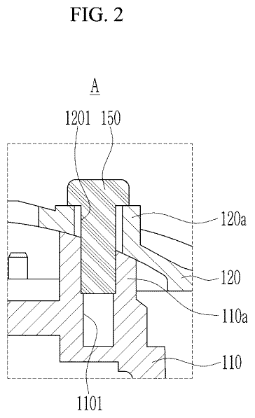

Hereinafter, a camera module according to an embodiment will be described with reference to FIGS. 1 and 2.

FIG. 1 is a cross-sectional view of a camera module according to an embodiment, and FIG. 2 is an enlarged cross-sectional view of portion A of the camera module according to an embodiment.

Referring to FIGS. 1 and 2, a camera module 100 according to an embodiment may include a housing 110, a supporting member 120 provided with a connector 121, and a lens module 130 accommodated in the housing 110.

According to an embodiment, the camera module 100 may have a housing 110 equipped with the lens module 130 mounted on the supporting member 120. The connector 121 may be connected to a vehicle and supply power and control signals to the lens module 130.

The housing 110 may be mutually connected to the supporting member 120. The housing 110 may have an internal space. A supply terminal of the connector 121, the lens module 130, and a circuit board 140 may be disposed in the internal space of the housing 110.

The supporting member 120 may be disposed at one end of the housing 110. The supporting member 120 may be a means for allowing the camera module 100 to be mounted on a vehicle. The supporting member 120 may be disposed to connect the lens module 130 and the vehicle to transmit a signal received from the vehicle to the lens module 130 and to supply power. The supporting member 120 may be disposed to surround the connector 121. The supporting member 120 may have an opening into which the connector 121 is inserted. For example, the supporting member 120 may be a bracket.

The connector 121 may be disposed so that the connection terminal is exposed on the outside of the supporting member 120. The connector 121 may have a connection terminal at one end and a supply terminal at the other end. The connector 121 may have a terminal shape that is generally distributed—for example, it may be provided with a terminal shape used in vehicle camera applications. However, it is not limited thereto, and anything that can be used for power supply or control signal transmission may be used.

The lens module 130 may include a lens barrel. The lens barrel may accommodate at least one lens inside.

The circuit board 140 may be disposed on one side of the lens module 130 along the optical axis direction. The circuit board 140 may be disposed between the lens module 130 and the connector 121. The circuit board 140 may be connected to the connector 121. Various active and passive chips, such as image sensors, may be mounted on the circuit board 140.

Hereinafter, the housing 110, the supporting member 120, and a coupling member 150 will be described in more detail with reference to FIGS. 2 to 4.

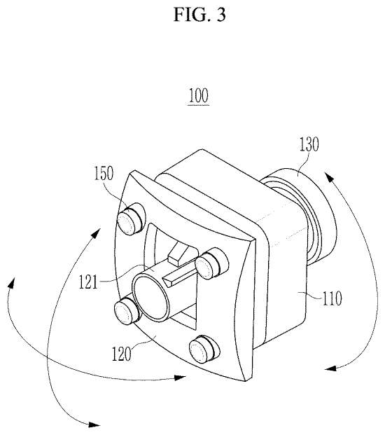

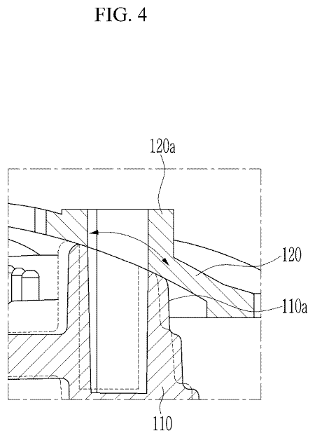

FIG. 3 is a perspective view of a camera module according to an embodiment. FIG. 4 is an enlarged cross-sectional view illustrating the movement of a camera module according to an embodiment.

FIG. 2 is a cross-sectional view showing an enlarged view of a coupling region where the housing 110 and the supporting member 120 are coupled in the camera module 100 according to an embodiment. In the coupling region, the housing 110 and the supporting member 120 may be coupled through the coupling member 150.

Referring to FIG. 2, the housing 110 may include a first portion 110a on one side. The supporting member 120 may include a second portion 120a disposed to face the first portion 110a. One end of the first portion 110a may have a curved contour. One end of the second portion 120a may have a curved contour that corresponds to the curved contour of the first portion 110a. The coupling member 150 may be disposed to mutually couple the first portion 110a and the second portion 120a.

The curved contour of the first portion 110a and the curved contour of the second portion 120a may match each other in curvature. The curved contour of the first portion 110a and the curved contour of the second portion 120a may each be part of concentric spheres of different sizes. Accordingly, when the first portion 110a and the second portion 120a are in contact with each other, the first portion 110a may move relatively to the second portion 120a.

The first portion 110a may have a first coupling portion 1101 that is opened toward the supporting member 120. The first coupling portion 1101 may be a recessed groove shape formed from one surface of the housing 110 so that a part of the coupling member 150 may be inserted. However, it is not limited thereto, and the first coupling portion 1101 may be in the form of a hole or an aperture that extends through one surface of the housing 110. The first coupling portion 1101 may be disposed at one end of the housing 110. The first coupling portion 1101 may extend in the optical axis direction.

The second portion 120a may be disposed to be in contact with the first portion 110a. The second portion 120a may have a second coupling portion 1201 in a region corresponding to the first coupling portion 1101. The second coupling portion 1201 may be opened on at least one side to allow the coupling member 150 to be inserted. The second coupling portion 1201 may be a hole shape or an aperture that extends through one surface of the supporting member 120, but is not limited thereto. The second coupling portion 1201 may extend in the optical axis direction.

The coupling member 150 may be inserted into the first coupling portion 1101 and the second coupling portion 1201. In other words, the housing 110 and the supporting member 120 may be mutually coupled by the coupling member 150 being coupled together to the first coupling portion 1101 and the second coupling portion 1201. In order to prevent the connecting member 150 from being detached while it is inserted into the first coupling portion 1101 or the second coupling portion 1201, the width of one end exposed to the outside of the supporting member 120 may be greater than the width of the second coupling portion 1201. Screw threads may be disposed on the external circumferential surface of the connecting member 150, and corresponding grooves may be disposed on the interior circumferential surfaces of the first coupling portion 1101 and the second coupling portion 1201. However, it is not limited thereto, and any method that can couple the housing 110 and the supporting member 120, such as laser fusion or ultrasonic fusion, may be used.

Referring to FIGS. 2 to 4, the first portion 110a may be disposed so that the housing 110 may move relatively to the supporting member 120 and contact the second portion 120a.

Referring to FIGS. 3 and 4, the housing 110 is rotatable around the optical axis of the lens module 130 and may be disposed to contact the supporting member 120. Here, in a state in which the curved contour of the first portion 110a and the curved contour of the second portion 120a are in contact, the housing 110 may move relatively to the supporting member 120. In other words, when the components of the camera module 100 are assembled in the housing 110, the housing 110 may rotate around the optical axis of the lens module 130, thereby enabling rotational alignment and adjustment.

Additionally, the housing 110 may rotate around a first axis perpendicular to the optical axis and may be disposed to contact the supporting member 120. Also, the housing 110 may rotate around the optical axis and a second axis perpendicular to the first axis, and may be disposed to be in contact with the supporting member 120. Here, in a state where the curved contour of the first portion 110a and the curved contour of the second portion 120a are in contact, the housing 110 may move relatively to the supporting member 120. In other words, when the components of the camera module 100 are assembled in the housing 110, the housing 110 may rotate around an axis perpendicular to the optical axis, thereby enabling alignment and adjustment of the optical axis.

After the rotational adjustment and optical axis adjustment, the coupling member 150 may be inserted into the first coupling member 1101 and into the second coupling member 1201 to affix the housing 110 and the supporting member 120.

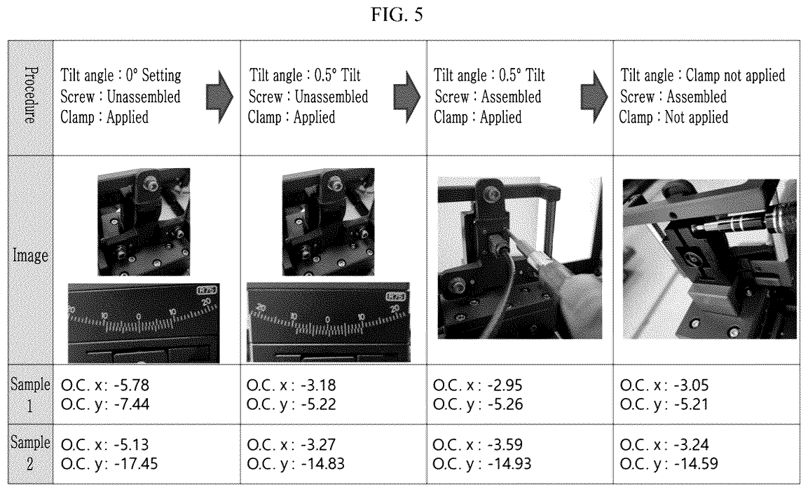

FIG. 5 illustrates the optical axis adjustment of a camera module according to an embodiment. FIG. 5 is a table showing the process and result of adjusting the optical axis of the camera module 100 by changing the position of the housing 110 while the housing 110 and the supporting member 120 are in contact.

In the table, O.C. (optical center) x may refer to the distance in the x-axis direction from the optical center, and O.C. y may refer to the distance in the y-axis direction from the optical center. Therefore, O.C. x and O.C. y values closer to zero may indicate that the optical axis has been adjusted to the desired position.

In Sample 1 and Sample 2, the housing 110 is tilted 0.5°from the initial state to adjust the optical axis, and then the screw, which is the coupling member 150, is assembled. Here, it can be seen that the values of O.C. x and O.C. y are closer to 0 compared to the initial value. In other words, it can be seen that the desired optical axis adjustment is possible when the supporting member 120 and the housing 110 are in contact, and the camera module 100 may then be affixed through the coupling member 150.

An aspect of the present disclosure attempts to provide a camera module capable of more precisely adjusting the optical axis and rotation, and improving the quality of the camera module.

According to the camera module in the above-described embodiment, it is possible to perform separate position adjustments during the process of assembling a supporting member such as a bracket and housing, thereby adjusting the optical axis and rotation more precisely to improve the quality of the camera module, e.g., by minimizing deterioration of image recognition or the occurrence of algorithm errors.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a lens module;
a housing, comprising a first portion having an end with a curved contour, accommodating the lens module; and
a supporting member, comprising a second portion disposed to face the first portion and having an end with a curved contour corresponding to the curved contour of the first portion, the supporting member disposed on one side of the housing,
wherein the first portion has a first coupling portion with an open top towards the supporting member,
and the second portion has a second coupling portion with an open top, at least on one side, in a region corresponding to the first coupling portion.

2. The camera module of claim 1, wherein
the first portion and the second portion are in contact with each other.

3. The camera module of claim 2, wherein
the first portion, in contact with the second portion, is disposed such that the housing is relatively movable with respect to the supporting member.

4. The camera module of claim 1, wherein
the housing, rotatable around on an optical axis of the lens module, is disposed to be in contact with the supporting member.

5. The camera module of claim 1, wherein
the housing, rotatable around a first axis perpendicular to an optical axis of the lens module, is disposed to be in contact with the supporting member.

6. The camera module of claim 5, wherein
the housing, rotatable around an optical axis and a second axis perpendicular to the first axis, is disposed to be in contact with the supporting member.

7. The camera module of claim 1, wherein
the supporting member comprises a bracket.

8. The camera module of claim 1, further comprising:
a coupling member disposed at the first coupling portion and the second coupling portion to mutually couple the housing and the supporting member.

9. The camera module of claim 1, wherein
the first coupling portion is a recessed groove on a surface of the housing.

10. The camera module of claim 1, wherein
the second coupling portion has an aperture that extends through a surface of the supporting member.

11. The camera module of claim 1, wherein
the curved contour of the first portion and the curved contour of the second portion have a same curvature.
